(19) United States
(12) Patent Application Publication
(10) Pub. No.: US 2026/0296404 A1
(43) Pub. Date: Oct. 1, 2026

(54) VEHICULAR TRAILERING ASSIST SYSTEM WITH SPEED CONTROL

(71) Applicant: Magna Electronics Inc., Auburn Hills, MI (US)

(72) Inventors: Nanubala Guru Siva Prasad, Karnataka (IN); Ramallingeswara Rao P, Andhra Pradesh (IN)

(21) Appl. No.: 19/572,957

(22) Filed: Mar. 20, 2026

Related U.S. Application Data
(60) Provisional application No. 63/777,061, filed on Mar. 25, 2025.

(51) Int. Cl. B60W 30/02; B60K 35/23; B60W 50/14; G06V 20/56; H04N 7/18

(52) U.S. Cl. CPC B60W 30/02; B60K 35/23; B60W 50/14; G06V 20/588; H04N 7/181; B60K 2360/16; B60K 2360/21; B60W 2050/146; B60W 2420/403; B60W 2520/10; B60W 2520/22; B60W 2552/35; B60W 2556/40; B60W 2556/50; B60W 2720/10

(57) ABSTRACT

A vehicular trailering assist system includes a rearward viewing camera disposed at a vehicle and viewing exterior and at least rearward of the vehicle. The camera is operable to capture image data representative of at least a portion of a trailer hitched to the vehicle. The system, with the trailer hitched to the vehicle, and as the vehicle travels in a forward direction of travel, and via processing at an electronic control unit (ECU) of image data captured by the camera, determines an angle between a longitudinal axis of the trailer and a longitudinal axis of the vehicle. The system, responsive to determining that the angle is greater than a threshold angle, and based on the vehicle travelling in the forward direction of travel at a speed greater than a threshold speed, generates an alert to a driver of the vehicle.

### CROSS REFERENCE TO RELATED APPLICATION

The present application claims the filing benefits of U.S. provisional application Ser. No. 63/777,061, filed Mar. 25, 2025, which is hereby incorporated herein by reference in its entirety.

### FIELD OF THE INVENTION

The present invention relates generally to a vehicle trailering assist system for a vehicle and, more particularly, to a vehicle trailering assist system that utilizes one or more cameras at a vehicle.

### BACKGROUND OF THE INVENTION

Use of imaging sensors in vehicular trailer assist systems is common and known. Examples of such known systems are described in U.S. Pat. Nos. 9,446,713 and 9,085,261, which are hereby incorporated herein by reference in their entireties.

### SUMMARY OF THE INVENTION

A vehicular trailering assist system includes a rearward viewing camera disposed at a vehicle equipped with the vehicular trailering assist system and viewing exterior of the equipped vehicle. The rearward viewing camera views at least rearward of the equipped vehicle. The rearward viewing camera is operable to capture image data representative of at least a portion of a trailer hitched to the equipped vehicle. The rearward viewing camera includes an imager that includes a CMOS imaging array having at least one million photosensors arranged in rows and columns. Image data captured by the rearward viewing camera is transferred to an electronic control unit (ECU). The ECU includes electronic circuitry and associated software, and the electronic circuitry of the ECU includes an image processor operable to process image data transferred to the ECU. The vehicular trailering assist system, with the trailer hitched to the equipped vehicle, and as the equipped vehicle travels in a forward direction of travel, and via processing at the ECU of image data captured by the rearward viewing camera, determines an angle between a longitudinal axis of the trailer and a longitudinal axis of the equipped vehicle.

The vehicular trailering assist system, responsive to determining that the angle between the longitudinal axis of the trailer and the longitudinal axis of the equipped vehicle is greater than a threshold angle, and based on the equipped vehicle travelling in the forward direction of travel at a speed greater than a threshold speed, generates an alert to a driver of the equipped vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a trailering assist system that is operable to monitor a trailer hitched to the vehicle as the vehicle travels in a forward direction of travel;

FIG. 2 is a schematic diagram showing the trailer jackknifing relative to the vehicle and showing the trailer swaying relative to the vehicle;

FIG. 3 is a schematic diagram showing the vehicle and trailer traveling along a curved portion of road; and

FIG. 4 is a schematic diagram of the trailering assist system.

### DESCRIPTION OF THE PREFERRED EMBODIMENTS

A vehicle and trailer maneuvering system or trailering assist system and/or driving assist system operates to capture images exterior of the vehicle and trailer being towed by the vehicle and may process the captured image data to determine a path of travel for the vehicle and trailer and to detect objects at or near the vehicle and in the predicted path of the vehicle, such as to assist a driver of the vehicle in maneuvering the vehicle and trailer in a rearward direction. The system includes an image processor or image processing system that is operable to receive image data from one or more cameras and may provide an output to a display device for displaying images representative of the captured image data. Optionally, the vision system may provide display, such as a rearview display or a top down or bird's eye or surround view display or the like.

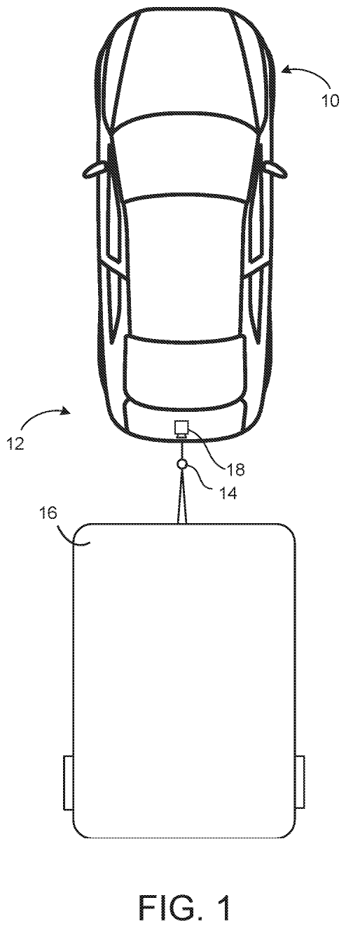

Referring now to the drawings and the illustrative embodiments depicted therein, a vehicle 10 includes a trailering assist system 12 that is operable to assist in backing up or reversing with a hitched trailer via, for example, a hitch 14 and may maneuver the vehicle 10 and trailer 16 toward a desired or selected location. The trailering assist system 12 includes at least one exterior viewing vehicle-based imaging sensor or camera, such as a rearward viewing imaging sensor or camera 18 (and the system may optionally include multiple exterior viewing imaging sensors or cameras, such as a sideward/rearward viewing camera at respective sides of the vehicle), which captures image data representative of the scene exterior of the vehicle 10, which includes the hitch 14 and/or trailer 16, with the camera 18 having a lens for focusing images at or onto an imaging array or imaging plane or imager of the camera (FIG. 1). Optionally, the camera is a center-high-mounted stop lamp (CHMSL) camera. Optionally, a forward viewing camera may be disposed at the windshield of the vehicle 10 and view through the windshield and forward of the vehicle 10, such as for a machine vision system (such as for traffic sign recognition, headlamp control, pedestrian detection, collision avoidance, lane marker detection and/or the like). The trailer maneuver assist system 12 includes a control or electronic control unit (ECU) or processor that is operable to process image data captured by the camera or cameras and may detect objects or the like and/or provide displayed images at a display device for viewing by the driver of the vehicle (the control and/or display device may be part of or incorporated in or at an interior rearview mirror assembly of the vehicle, or the control and/or the display device may be disposed elsewhere at or in the vehicle). The data transfer or signal communication from the camera to the ECU may comprise any suitable data or communication link, such as a vehicle network bus or the like of the equipped vehicle.

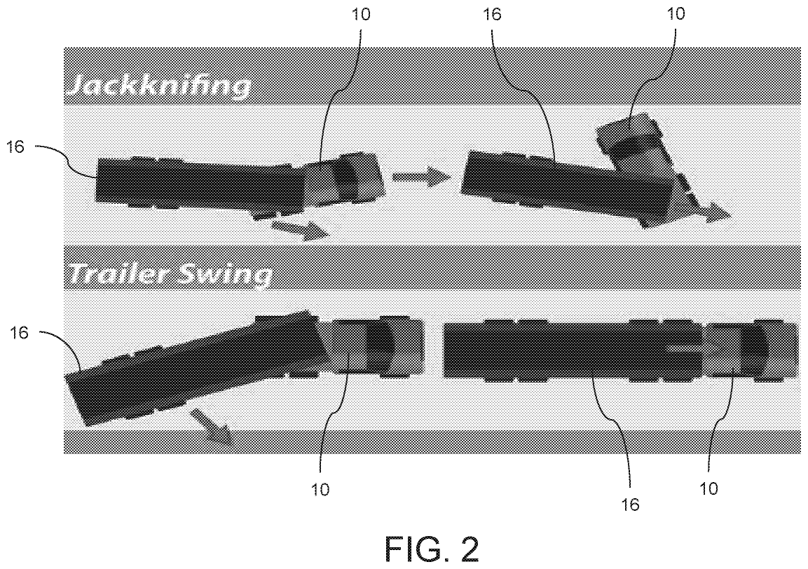

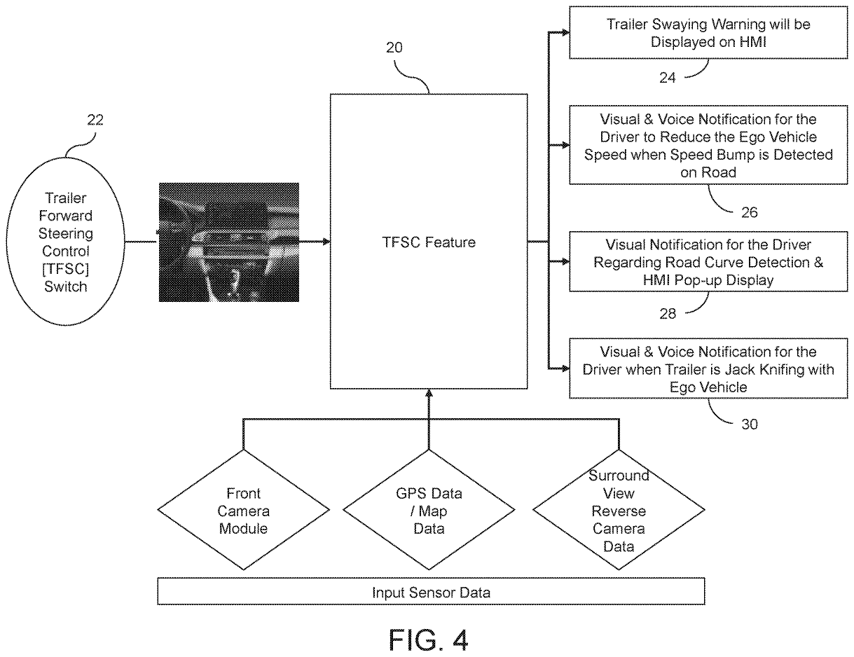

As shown in FIGS. 2-4, the trailering assist system 12 may include or be associated with a trailer forward steering control (TFSC) assist feature or system 20 that may at least partially control operation of the vehicle 10 and/or provide alerts to the driver of the vehicle 10 as the vehicle 10 travels in a forward direction of travel while towing the trailer 16. That is, the TFSC system 20 may operate as the vehicle 10 travels in the forward direction of travel to monitor conditions of the trailer 16 relative to the vehicle 10, to monitor operation of the vehicle 10, to monitor road conditions along a path of travel of the vehicle 10 and/or environmental conditions exterior the vehicle and the TFSC system 20 adjusts operation of the vehicle 10 and/or generates alerts to the driver of the vehicle 10.

The TFSC system 20 may activate responsive to the trailer 16 being connected to the hitch 14 of the vehicle 10. For example, based on processing of image data captured by the camera 18, the system may detect the trailer 16 and activate the TFSC feature 20. In some examples, the TFSC system 20 may activate responsive to a user input, such as a switch or button 22 disposed within the interior cabin of the vehicle 10. For example, the TFSC system 20 may activate concurrently with one or more other advanced driver assistance systems (ADAS) of the vehicle 10, such as an adaptive cruise control system of the vehicle, a lane keep assist system of the vehicle, an at least partially autonomous driving control system of the vehicle, and the like. Optionally, responsive to detecting the trailer 16 hitched to the vehicle 10, the system may prompt the driver to activate the TFSC system 20, such as via an audio message played over an audio system of the vehicle or a message displayed at a head up display (HUD) of the vehicle, an infotainment display of the vehicle, a gauge cluster display of the vehicle, and the like. Thus, the TFSC system 20 may operate continuously when the vehicle 10 is towing the trailer 16 (e.g., to at least partially control operation of the vehicle, to monitor the trailer 16, monitor the environment, and/or to provide alerts to the driver of the vehicle) or the TFSC system 20 may be turned on and off when the vehicle 10 is towing the trailer 16, such as to provide trailering assistance when activated and to allow for manual operation of the vehicle 10 when not activated.

Based on sensor data captured by one or more sensors at the vehicle 10 and/or based on signals from one or more systems of the vehicle 10, the TFSC system 20 monitors the vehicle 10 and trailer 16 as the vehicle 10 travels in a forward direction of travel (e.g., with a propulsion system or gear selector of the vehicle in a forward driving mode). For example, the system 20 may process or utilize image data or images captured by the rearward viewing camera 18, the forward viewing camera (e.g., a windshield mounted camera), and/or one or more other cameras at the vehicle (e.g., a camera disposed at a side portion of the vehicle and that views at least rearward along a side of the vehicle). Additionally, the system 20 may receive signals and/or map data from a global positioning system (GPS) of the vehicle 10.

Responsive to detecting an adverse condition related to the trailer 16, the TFSC system 20 may adjust operation of the vehicle 10 and/or generate an alert to the driver of the vehicle 10. For example, the TFSC system 20 may generate visual alerts (e.g., by illuminating an icon at the gauge cluster of the vehicle, by displaying a message at the infotainment display or gauge cluster display or HUD of the vehicle, and the like) and/or audio alerts (e.g., tones or chimes or audio messages played over the audio system of the vehicle) to the driver of the vehicle, as discussed further below.

In the illustrated example of FIG. 2, the TFSC system 20 may be configured to detect an adverse condition related to the trailer 16 when the trailer 16 is swaying or swinging relative to the vehicle 10 as the vehicle 10 travels along the road. That is, with the vehicle 10 travelling along a path of travel, the trailer 16 may sway or oscillate from side to side relative to the vehicle 10 and the path of travel. This may be caused by an improper weight distribution in the trailer, external forces like wind or air turbulence, road conditions like potholes or uneven surfaces, and the like, and may present a danger to the vehicle 10, the trailer 16 and/or other vehicles 10 on the road.

Trailer movement may be detected based on processing of image data captured by the rearward viewing camera 18 and the TFSC system 20 may determine undesirable trailer sway responsive to detecting that the trailer 16 is angled relative to the vehicle 10 (e.g., a longitudinal axis of the vehicle) or path of travel by more than a threshold amount (e.g., by 5 degrees or more, by 10 degrees or more, by 15 degrees or more, and the like). Further, to avoid false determinations and because the trailer 16 may pivot more relative to the vehicle 10 at lower speeds than at high speeds, the threshold amount may be adjusted based on the speed of the vehicle 10 (e.g., so that the threshold angle of the longitudinal axis of the trailer relative to the longitudinal axis of the vehicle is lower when the vehicle is travelling at higher speeds and the threshold angle is higher when the vehicle is traveling at lower speeds). Optionally, the TFSC system 20 may only monitor for trailer sway at higher speeds, such as when the vehicle 10 is travelling at speeds greater than about 80 kilometers per hour or more, 100 kilometers per hour or more, and the like.

Responsive to determining that the trailer 16 is moving relative to the vehicle 10 or path of travel more than the threshold amount, the TFSC system 20 may generate a first alert 24 to the driver of the vehicle 10. The first alert 24 may include a message displayed on a display screen of the infotainment system or gauge cluster or the HUD of the vehicle, and the message may include a prompt for the driver to alter driving behavior. For example, the message may instruct or encourage the driver to reduce the speed of the vehicle 10 to reduce the swaying of the trailer 16 and/or to bring the vehicle 10 to a stop so that any issue with the trailer 16 may be corrected. Optionally, such as when operation of the vehicle 10 is being at least partially controlled by an autonomous or semi-autonomous driving system as the vehicle 10 travels along the road, the TFSC system 20 may adjust operation of the vehicle 10 to reduce the speed of the vehicle 10 and/or bring the vehicle 10 to a stop at a safe location.

In other words, the system may provide a trailer swaying warning on the vehicle HUD at high speeds (e.g., up to about 80 kilometers per hour or more). During forward motion of the vehicle 10, as soon as swaying is more than five degrees within the defined speed limit (e.g., 80 kilometers per hour speed limit), the swaying warning may be displayed on a vehicle human machine interface (HMI) to notify the driver so that the driver may reduce the speed of the equipped vehicle until the trailer 16 is aligned with the vehicle 10 or path of travel (i.e., within the threshold angle relative to the vehicle or path of travel of the vehicle).

Moreover, the TFSC system 20 may be configured to detect a road condition forward of the vehicle 10 and in the path of travel of the vehicle 10, such as a speed bump, object in the road, pothole or uneven road surface, and other obstructions that require the vehicle 10 and trailer 16 to approach or pass at reduced speeds. For example, the TFSC system 20 may detect the road condition based on processing of image data captured by the forward viewing camera of the vehicle 10.

Responsive to determination that the vehicle 10 and trailer 16 are travelling at a speed greater than a threshold speed (e.g., 40 kilometers per hour or more, 60 kilometers per hour or more, 80 kilometers per hour or more, and the like), and responsive to detection of an obstruction (e.g., a speed bump) in the path of travel of the vehicle, the TFSC system 20 may generate a second alert 26 to the driver of the vehicle 10. The threshold speed may be adjusted based on the type or size or classification of obstruction detected in the path of travel of the vehicle 10. The second alert 26 may include a message displayed on the display screen of the infotainment system or gauge cluster or the HUD of the vehicle 10, and the message may instruct or encourage the driver to reduce the speed of the vehicle 10 as the vehicle 10 and trailer 16 pass the obstruction. Optionally, the TFSC system 20 may adjust operation of the vehicle 10 to reduce the speed of the vehicle 10 until the vehicle 10 and trailer 16 have passed the obstruction.

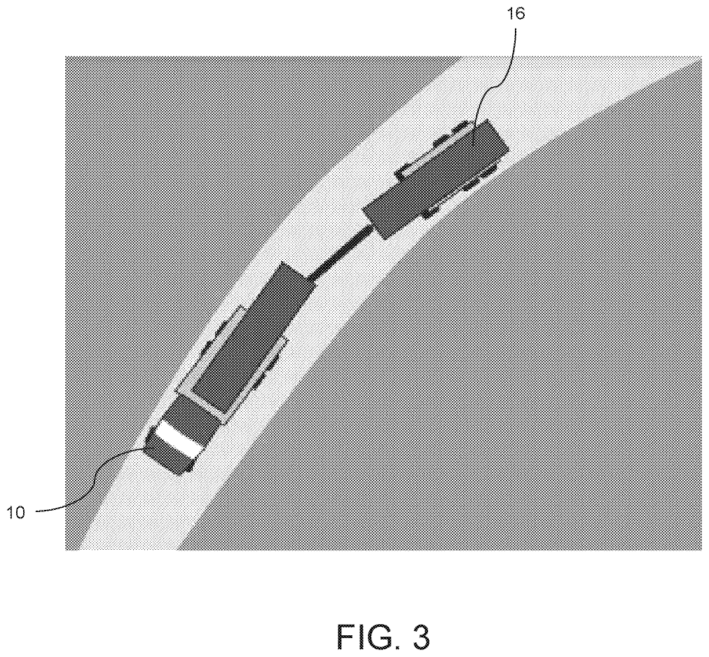

In the illustrated example of FIG. 3, the TFSC system 20 may be configured to detect a curve forward of the vehicle and in the path of travel of the vehicle 10. If the vehicle is improperly driven along the curved portion of the path of travel, such as steered too closely to an inside lane boundary, the trailer 16 may travel toward or into an adjacent lane of travel, creating a potential danger to the trailer 16 and other vehicles. The TFSC system 20 may detect the curve in the path of travel based at least partially on map data from the GPS system of the vehicle (e.g., indicating a turn or curve in the road on which the vehicle is traveling) and/or based at least partially on image data captured by the forward viewing camera of the vehicle 10. That is, based on a fusion of map data and front camera data (which is placed behind the front windshield), the road curve may be detected.

In response to detecting the road curve, the TFSC system 20 may generate a third alert 28 to the driver of the vehicle 10. The third alert 28 may include a message displayed on the display screen of the infotainment system or gauge cluster or the HUD of the vehicle 10, and the message may instruct or encourage the driver to reduce the speed of the vehicle 10 as the vehicle 10 and trailer 16 travel along the curved portion of the road. Optionally, the TFSC system 20 may adjust operation of the vehicle 10 to reduce the speed of the vehicle 10 until the vehicle 10 and trailer 16 have traveled past the curved portion of the road. In some examples, in response to detecting the road curve, the TFSC system 20 may prompt the driver to activate the TFSC system 20 so that the TFSC system 20 may provide trailer steering alignment via controlling the steering of the vehicle 10. That is, the TFSC system 20 may at least partially control operation of the vehicle 10 as the vehicle 10 and trailer 16 travel along the curved portion of the road to ensure proper alignment of the vehicle 10 and the trailer 16.

Further, the TFSC system 20 may be configured to detect that the vehicle 10 and trailer 16 are jackknifing during forward driving maneuvers or may be likely to jackknife, where the trailer 16 may be at a severe acute angle relative to the vehicle 10 (e.g., 45 degrees or less, 30 degrees or less, and the like), causing the vehicle 10 to lose control (FIG. 2). For example, the vehicle 10 and trailer 16 may be at risk of jackknifing during slippery road conditions, where the vehicle 10 executes a turn and the trailer 16 and rear portion of the vehicle continue in the direction of the previous path of travel, causing the jackknife.

In some examples, the system may determine that the vehicle 10 and trailer 16 are at risk of jackknifing based on determination that the vehicle 10 is travelling above a threshold speed (e.g., 40 kilometers per hour or more, 60 kilometers per hour or more, 80 kilometers per hour or more, and the like), and that slippery road conditions are present.

For example, based on processing of image data captured by the forward viewing camera of the vehicle 10, the system may determine presence of snow, ice, moisture, and the like on the road.

In response to determining that the vehicle 10 and trailer 16 are at risk of jackknifing, the TFSC system 20 may generate a fourth alert 30 to the driver of the vehicle 10. The fourth alert 30 may include a message displayed on the display screen of the infotainment system or gauge cluster or the HUD of the vehicle 10, and the message may instruct or encourage the driver to reduce the speed of the vehicle 10 to reduce the chance of jackknifing. Optionally, the TFSC system 20 may adjust operation of the vehicle 10 to reduce the speed of the vehicle 10 until determination that the vehicle 10 and trailer 16 are not at risk of jackknifing.

For autonomous vehicles suitable for deployment with the system, an occupant of the vehicle may, under particular circumstances, be desired or required to take over operation/control of the vehicle and drive the vehicle so as to avoid potential hazard for as long as the autonomous system relinquishes such control or driving. Such an occupant of the vehicle thus becomes the driver of the autonomous vehicle. As used herein, the term “driver” refers to such an occupant, even when that occupant is not actually driving the vehicle, but is situated in the vehicle so as to be able to take over control and function as the driver of the vehicle when the vehicle control system hands over control to the occupant or driver or when the vehicle control system is not operating in an autonomous or semi-autonomous mode.

Typically, an autonomous vehicle would be equipped with a suite of sensors, including multiple machine vision cameras deployed at the front, sides and rear of the vehicle, multiple radar sensors deployed at the front, sides and rear of the vehicle, and/or multiple lidar sensors deployed at the front, sides and rear of the vehicle. Typically, such an autonomous vehicle will also have wireless two way communication with other vehicles or infrastructure, such as via a car2car (V2V) or car2x communication system.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. No. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774;

US-2014-0327772; US-2014-0320636; US-2014-0293057; US-2014-0309884; US-2014-0226012; US-2014-0293042; US-2014-0218535; US-2014-0218535; US-2014-0247354;

US-2014-0247355; US-2014-0247352; US-2014-0232869; US-2014-0211009; US-2014-0160276; US-2014-0168437; US-2014-0168415; US-2014-0160291; US-2014-0152825;

US-2014-0139676; US-2014-0138140; US-2014-0104426; US-2014-0098229; US-2014-0085472; US-2014-0067206; US-2014-0049646; US-2014-0052340; US-2014-0025240;

US-2014-0028852; US-2014-005907; US-2013-0314503; US-2013-0298866; US-2013-0222593; US-2013-0300869; US-2013-0278769; US-2013-0258077; US-2013-0258077;

US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Optionally, the camera may comprise a forward viewing camera, such as disposed at a windshield electronics module (WEM) or the like. The forward viewing camera may utilize aspects of the systems described in U.S. Pat. Nos. 12,174,448; 11,635,672; 11,124,130; 9,896,039; 9,871,971; 9,596,387; 9,487,159; 8,256,821; 7,480,149; 6,824,281 and/or 6,690,268, which are all hereby incorporated herein by reference in their entireties.

The system may utilize aspects of the trailering assist systems or trailer angle detection systems or trailer hitch assist systems described in U.S. Pat. Nos. 12,071,132; 11,964,689; 11,787,339; 11,613,210; 10,755,110; 10,733,757; 10,706,291; 10,638,025; 10,586,119; 10,552,976; 10,532,698; 10,160,382; 10,086,870; 9,558,409; 9,446,713; 9,085,261 and/or 6,690,268, and/or U.S. Publication Nos. US-2022-0212599; US-2022-0028111; US-2022-0027644; US-2022-0024391; US-2021-0170947; US-2021-0170820;

US-2021-0078634; US-2021-0053572; US-2020-0406967; US-2020-0361397; US-2020-0356788; US-2020-0334475; US-2020-0017143; US-2019-0347825; US-2019-0118860;

US-2019-0064831; US-2018-0276838; US-2018-0215382; US-2017-0254873; US-2017-0217372 and/or US-2015-0002670, and/or International Publication No. WO 2021/0127693, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular trailering assist system, the vehicular trailering assist system comprising:
a rearward viewing camera disposed at a vehicle equipped with the vehicular trailering assist system and viewing exterior of the equipped vehicle, and wherein the rearward viewing camera views at least rearward of the equipped vehicle;
wherein the rearward viewing camera is operable to capture image data representative of at least a portion of a trailer hitched to the equipped vehicle;
wherein the rearward viewing camera comprises an imager, and wherein the imager comprises a CMOS imaging array having at least one million photosensors arranged in rows and columns;
an electronic control unit (ECU);
wherein image data captured by the rearward viewing camera is transferred to the ECU;
wherein the ECU comprises electronic circuitry and associated software, and wherein the electronic circuitry of the ECU comprises an image processor operable to process image data transferred to the ECU;
wherein the vehicular trailering assist system, with the trailer hitched to the equipped vehicle, and as the equipped vehicle travels in a forward direction of travel, and via processing at the ECU of image data captured by the rearward viewing camera, determines an angle between a longitudinal axis of the trailer and a longitudinal axis of the equipped vehicle; and
wherein the vehicular trailering assist system, responsive to determining that the angle between the longitudinal axis of the trailer and the longitudinal axis of the equipped vehicle is greater than a threshold angle, and based on the equipped vehicle travelling in the forward direction of travel at a speed greater than a threshold speed, generates an alert to a driver of the equipped vehicle.

2. The vehicular trailering assist system of claim 1, wherein the threshold angle comprises 5 degrees.

3. The vehicular trailering assist system of claim 1, wherein the threshold speed comprises 80 kilometers per hour.

4. The vehicular trailering assist system of claim 1, wherein the alert comprises a message displayed to the driver of the equipped vehicle, and wherein the message indicates that the speed of the equipped vehicle should be reduced.

5. The vehicular trailering assist system of claim 4, wherein the message is displayed at a head up display (HUD) of the equipped vehicle.

6. The vehicular trailering assist system of claim 1, wherein the vehicular trailering assist system is operable to at least partially control operation of the equipped vehicle as the equipped vehicle travels in the forward direction of travel, and wherein, responsive to determining that the angle between the longitudinal axis of the trailer and the longitudinal axis of the equipped vehicle is greater than a threshold angle, and based on the equipped vehicle travelling in the forward direction of travel at a speed greater than a threshold speed, the vehicular trailering assist system adjusts operation of the equipped vehicle to reduce the speed of the equipped vehicle below the threshold speed.

7. The vehicular trailering assist system of claim 1, wherein a forward viewing camera is disposed at the equipped vehicle and views exterior of the equipped vehicle, and wherein the forward viewing camera views at least forward of the equipped vehicle toward the forward direction of travel.

8. The vehicular trailering assist system of claim 7, wherein the vehicular trailering assist system, with the trailer hitched to the equipped vehicle, and as the equipped vehicle travels in the forward direction of travel, and via processing at the ECU of image data captured by the forward viewing camera, determines a road condition in a path of travel of the equipped vehicle, and wherein the vehicular trailering assist system generates a second alert to the driver of the equipped vehicle responsive to determining the road condition in the path of travel of the equipped vehicle.

9. The vehicular trailering assist system of claim 8, wherein the second alert comprises a message displayed to the driver of the equipped vehicle, and wherein the message indicates that the speed of the equipped vehicle should be reduced.

10. The vehicular trailering assist system of claim 8, wherein the road condition comprises presence of a speed bump.

11. The vehicular trailering assist system of claim 8, wherein the road condition comprises a curved portion of the path of travel.

12. The vehicular trailering assist system of claim 11, wherein the vehicular trailering assist system determines the curved portion of the path of travel based at least in part on map data received from a global positioning system (GPS) of the equipped vehicle.

13. A vehicular trailering assist system, the vehicular trailering assist system comprising:
a rearward viewing camera disposed at a vehicle equipped with the vehicular trailering assist system and viewing exterior of the equipped vehicle, and wherein the rearward viewing camera views at least rearward of the equipped vehicle;
wherein the rearward viewing camera is operable to capture image data representative of at least a portion of a trailer hitched to the equipped vehicle;
a forward viewing camera disposed at the equipped vehicle and viewing exterior of the equipped vehicle, wherein the forward viewing camera views at least forward of the equipped vehicle;
wherein each of the rearward viewing camera and the forward viewing camera comprises an imager, and wherein each imager comprises a CMOS imaging array having at least one million photosensors arranged in rows and columns;
an electronic control unit (ECU);
wherein image data captured by the rearward viewing camera is transferred to the ECU, and wherein image data captured by the forward viewing camera is transferred to the ECU;
wherein the ECU comprises electronic circuitry and associated software, and wherein the electronic circuitry of the ECU comprises an image processor operable to process image data transferred to the ECU;
wherein the vehicular trailering assist system, with the trailer hitched to the equipped vehicle, and as the equipped vehicle travels in a forward direction of travel, and via processing at the ECU of image data captured by the rearward viewing camera, determines an angle between a longitudinal axis of the trailer and a longitudinal axis of the equipped vehicle;
wherein the vehicular trailering assist system, with the trailer hitched to the equipped vehicle, and as the equipped vehicle travels in the forward direction of travel, and at least in part via processing at the ECU of image data captured by the forward viewing camera, is operable to at least partially control operation of the equipped vehicle as the equipped vehicle travels in the forward direction of travel; and
wherein the vehicular trailering assist system, responsive to determining that the angle between the longitudinal axis of the trailer and the longitudinal axis of the equipped vehicle is greater than a threshold angle, and based on the equipped vehicle travelling in the forward direction of travel at a speed greater than a threshold speed, adjusts operation of the equipped vehicle to reduce the speed of the equipped vehicle below the threshold speed.

14. The vehicular trailering assist system of claim 13, wherein the threshold angle comprises 5 degrees.

15. The vehicular trailering assist system of claim 13, wherein the threshold speed comprises 80 kilometers per hour.

16. The vehicular trailering assist system of claim 13, wherein the vehicular trailering assist system, with the trailer hitched to the equipped vehicle, and as the equipped vehicle travels in the forward direction of travel, and via processing at the ECU of image data captured by the forward viewing camera, determines a road condition in a path of travel of the equipped vehicle, and wherein the vehicular trailering assist system, responsive to determining the road condition in the path of travel of the equipped vehicle, adjusts operation of the equipped vehicle to reduce the speed of the equipped vehicle below the threshold speed.

17. The vehicular trailering assist system of claim 16, wherein the road condition comprises presence of a speed bump.

18. The vehicular trailering assist system of claim 16, wherein the road condition comprises a curved portion of the path of travel.

19. A vehicular trailering assist system, the vehicular trailering assist system comprising:
a rearward viewing camera disposed at a vehicle equipped with the vehicular trailering assist system and viewing exterior of the equipped vehicle, and wherein the rearward viewing camera views at least rearward of the equipped vehicle;
a forward viewing camera disposed at the equipped vehicle and viewing exterior of the equipped vehicle, wherein the forward viewing camera views at least forward of the equipped vehicle;
wherein the rearward viewing camera is operable to capture image data representative of at least a portion of a trailer hitched to the equipped vehicle;
wherein each of the rearward viewing camera and the forward viewing camera comprises an imager, and wherein each imager comprises a CMOS imaging array having at least one million photosensors arranged in rows and columns;
an electronic control unit (ECU);
wherein image data captured by the rearward viewing camera is transferred to the ECU, and wherein image data captured by the forward viewing camera is transferred to the ECU;
wherein the ECU comprises electronic circuitry and associated software, and wherein the electronic circuitry of the ECU comprises an image processor operable to process image data transferred to the ECU;
wherein the vehicular trailering assist system, with the trailer hitched to the equipped vehicle, and as the equipped vehicle travels in a forward direction of travel, and via processing at the ECU of image data captured by the rearward viewing camera, determines an angle between a longitudinal axis of the trailer and a longitudinal axis of the equipped vehicle;
wherein the vehicular trailering assist system, with the trailer hitched to the equipped vehicle, and as the equipped vehicle travels in the forward direction of travel, and via processing at the ECU of image data captured by the forward viewing camera, determines a road condition in a path of travel of the equipped vehicle;
wherein the vehicular trailering assist system, responsive to determining that the angle between the longitudinal axis of the trailer and the longitudinal axis of the equipped vehicle is greater than a threshold angle, and based on the equipped vehicle travelling in the forward direction of travel at a speed greater than a threshold speed, generates a first alert to a driver of the equipped vehicle;
wherein the vehicular trailering assist system generates a second alert to the driver of the equipped vehicle responsive to determining the road condition in the path of travel of the equipped vehicle; and
wherein each of the first alert and the second alert comprises a message displayed to the driver of the equipped vehicle, and wherein each message indicates that the speed of the equipped vehicle should be reduced.

20. The vehicular trailering assist system of claim 19, wherein each message is displayed at a head up display (HUD) of the equipped vehicle.
